(19) United States
(12) Patent Application Publication
(10) Pub. No.: US 2013/0100641 A1
(43) Pub. Date: Apr. 25, 2013

(54) LED Lamp

(71) Applicant: Marcus Zhang, Yuyao (CN)

(72) Inventor: Marcus Zhang, Yuyao (CN)

(21) Appl. No.: 13/379,034

(22) PCT Filed: Oct. 26, 2011
(86) PCT No.: PCT/CN2011/081333

§ 371 Date: Dec. 19, 2011

(30) Foreign Application Priority Data
Oct. 25, 2011 (CN) 201110327417.5

(51) Int. Cl. F21V 13/14

(52) U.S. Cl. 362/84

(57) ABSTRACT

The present patent application discloses a LED lamp, including a substrate on which LED assemblies are mounted, the surface of LED assemblies being covered with transparent heat conductor and having blocking wall arranged around; the LED assemblies are further coupled with a transparent lampshade that has a reflective ring provided thereon, the LED assemblies are disposed in a sealed cavity constituted by the substrate and the transparent lampshade, and the phosphor mixture provided on the transparent lampshade is separated from the LED assemblies.

### FIELD OF THE PATENT APPLICATION

The present patent application relates to illumination technical field, more particularly, to a LED lamp.

### BACKGROUND

As a new concept solid light source, LED has recently become one of the most prosperous new-high technology in the world with its incomparable technical advantages of energy-saving, environmental- protection, long-work duration and high-controllability.

With the increasing improvements of the light efficiency of the LED light source and its wider and wider range of application, LED light source will definitely take the place of the conventional light source. However, the light irradiation angle of the current high-powered LED light sources is relatively limited, usually in a range of 80 to 140 degrees. Thus, with respect to the increasing demands on LED light source technology, the problems of glaring, large amount of light energy loss, non-concentration of the light beam, weak penetration and insufficient light intensity should be well tackled, or otherwise the LED illumination quality would be greatly affected. Therefore, how to control the light irradiation angle of the LED light sources within a desired range, i.e., introducing the optical light-concentration and optical light-diffusion technologies into LED technical field, so as to fulfill the target of light-concentration and light-diffusion, has become an important aspect of the development of LED technology.

### SUMMARY

In order to address such above technical problems, the present patent application provides a LED lamp to overcome the defects of unobvious effects of light concentration and light diffusion as well as a series of unstable light-color-electric parameters caused by the high temperature because of phosphor mixture and chip being encapsulated together.

In order to solve the above problems, the technical solution employed by the present patent application is as follows: a LED lamp, including a substrate on which LED assemblies are mounted, the surface of the LED assemblies being covered with transparent heat conductor and having blocking wall arranged around; the LED assemblies further are coupled with a transparent lampshade that has a light reflecting ring provided thereon, and the LED assemblies are disposed in a sealed cavity constituted by the substrate and the transparent lampshade, and phosphor mixture provided on the transparent lampshade is separated from the LED assemblies.

Further, the transparent lampshade is a light concentrating transparent lampshade, which has a diameter less than that of the substrate and a shape of semi-oval convex lens, the light-concentration transparent lampshade being made of epoxy resin, transparent silicone or plastic glass.

Further, the transparent lampshade is a light diffusing transparent lampshade, which has a diameter less than that of the substrate and a shape of a spherical olive, the light-diffusion transparent lampshade being made of epoxy resin, transparent silicone or plastic glass.

Further, the transparent heat conductor is in a shape of concave lens, plane lens or convex lens.

Further, the blocking wall and the light reflecting ring are made of highly reflective heat-conductive plastic, rubber, or metal plated UV paint.

Further, chips of the LED assemblies are blue light chips.

Further, the substrate is made of ceramics or aluminum.

Further, the phosphor mixture is coated outside, inside or filled in the transparent lampshade, or, the phosphor mixture together with transparent silicone or epoxy resin are directly molded into the transparent lampshade.

Further, the transparent heat conductor is made of silicon rubber or epoxy resin.

In comparison with the prior art, the present patent application has the following advantages:

1. The use of the light concentrating transparent lampshade effectively makes the irradiation light of the LED lamp have concentration of light beam, strong penetration and sufficient illuminating intensity and realize the effect of concentrating light from different angles; the use of the light diffusing transparent lampshade effectively makes the irradiation light of the LED assemblies emit at an angle of larger than 270 degrees and evenly, thus the problem of glaring being avoided.

2. The LED assemblies are separated from the phosphor mixture, and in the LED assemblies, transparent heat conducting material is used for protection and highly reflective material is used as blocking wall. Therefore, the present patent application not only increases light efficiency while protecting light from leaking, but also reduces the heat collection of the LED lamp and have a good heat dispersion performance, thereby improving the stability of light flux, color temperature and electric parameter of the whole system, and at the same time increasing the light flux maintenance ratio while decreasing the light attenuation.

3. The configuration of separation of the phosphor mixture from the LED assemblies facilitates detachment of the LED assemblies and the supply of powder of the transparent lampshade, so as to easily control the consistency of the product and make chromatic aberration of the product less.

### BRIEF DESCRIPTIONS OF THE DRAWINGS

FIG. 1 is a front view of the light concentration solution of a LED lamp according to the present patent application;

FIG. 2 is an exploded view of the light concentration solution of a LED lamp as shown in FIG. 1;

FIG. 3 is a front view of the light diffusion solution of a LED lamp according to the present patent application; and

FIG. 4 is an exploded view of the light diffusion solution of a LED lamp as shown in FIG. 3.

### DETAILED DESCRIPTION

The details of the present patent application are set forth in the accompanying drawings and the embodiments below. It should be understood that the following embodiment is used for illustrative purpose rather than limitation of the scope of the patent application.

A LED lamp includes a substrate, which is made of ceramics or aluminum and on which LED assemblies are mounted. The chips on LED assemblies are blue light chips. The surface of the LED assemblies is covered with the transparent heat conductor made of the materials such as silicone or epoxy resin. The transparent heat conductor has properties of heat-dispersion, transparency, insulation, and seal so as to protect LED assemblies and transmit light. The transparent heat conductor may be shaped of concave, plane or convex lenses so as to obtain an effect of matching light at one time. The LED assemblies has a blocking wall made of highly reflective heat-conductive plastic or rubber or metal plated UV paint (i.e., Ultraviolet Curing Paint, which is also referred to as photoinitiation coating) arranged around so as to obtain effects of reflecting the blue light and conducting heat. The LED assemblies further couples with a transparent lampshade that has a light reflecting ring made of highly reflective heat-conductive plastic or rubber or metal plated UV paint (i.e., Ultraviolet Curing Paint, which is also referred to as photoinitiation coating), wherein the LED assemblies and the transparent lampshade are formed by two separated members. A sealed (closed) cavity constituted by the substrate and the transparent lampshade has LED assemblies disposed therein. The phosphor mixture is separated from the LED assemblies with a certain gap.

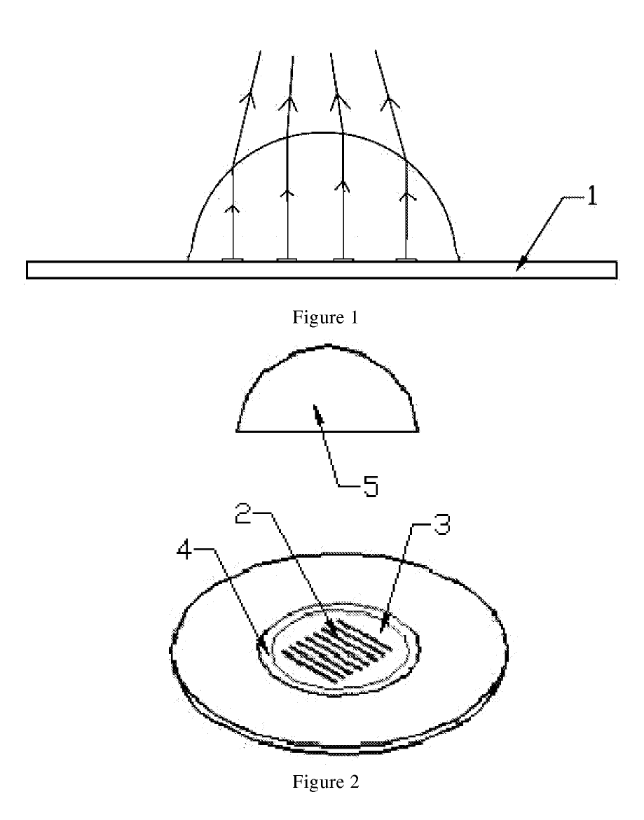

FIGS. 1 and 2 show an embodiment of concentrating solution of LED light, including a substrate 1 on which LED assemblies 2 with blue light chips are mounted. The surface of LED assemblies 2 is covered with a transparent heat conductor 3. The LED assemblies 2 has a blocking wall 4 made of highly reflective heat-conductive plastic or rubber or metal plated UV paint (i.e., Ultraviolet Curing Paint, which is also referred to as photoinitiation coating) arranged around. A light concentrating transparent lampshade 5 as a transparent lampshade is coupled with the LED assemblies 2. The LED assemblies 2 are disposed in a cavity constituted by the substrate 1 and the light concentrating transparent lampshade 5. The phosphor mixture can be coated outside or inside or filled in the transparent lampshade 5, or alternatively, the phosphor mixture together with transparent silicone and epoxy resin may be directly molded into the transparent lampshade 5. The white light generated by exciting inner-wall phosphor mixture using the blue light chips concentrates to the center. The phosphor mixture is separated from LED assemblies 2 with a certain gap.

The light concentrating transparent lampshade 5 has a diameter less than that of the substrate 1 and a shape of semi-oval convex lens. The light concentrating transparent lampshade 5 is made of materials such as epoxy resin or transparent silicone or plastic glass.

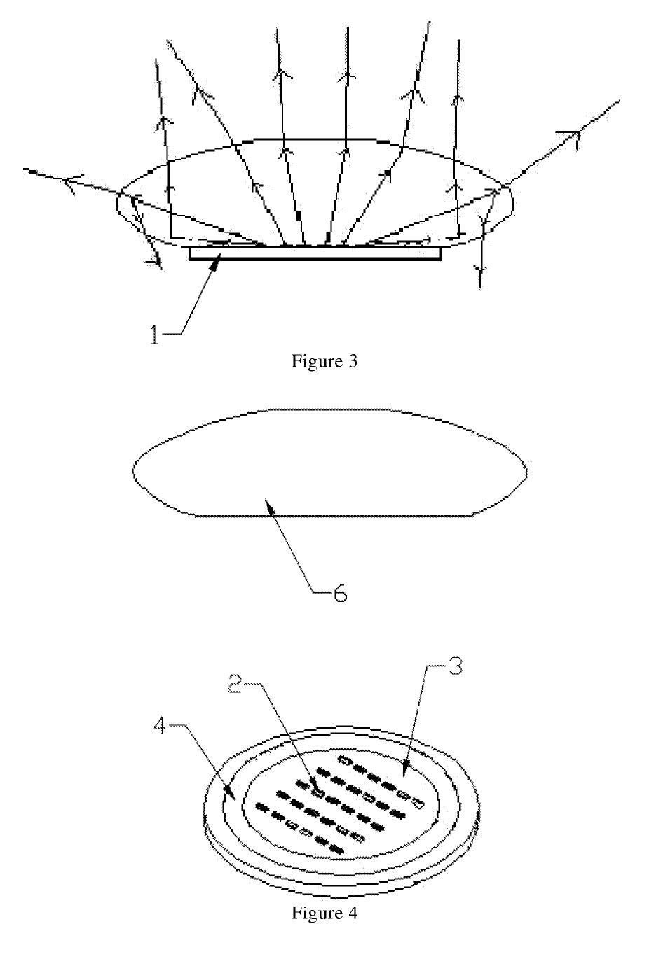

FIGS. 3 and 4 show an embodiment of light diffusing solution of LED lamp, including a substrate 1 on which LED assemblies 2 with blue light chips are mounted. The surface of the LED assemblies 2 is covered with a transparent heat-conductor 3. The LED assemblies 2 has a blocking wall 4 made of highly reflective heat-conductive plastic or rubber or metal plated UV paint (i.e., Ultraviolet Curing Paint, which is also referred to as photoinitiation coating) arranged around. A light diffusing transparent lampshade 6 as a transparent lampshade is coupled with the LED assemblies for changing the transmission direction of the irradiation light. The LED assemblies 2 are disposed in a sealed (closed) cavity constituted by the substrate 1 and the light diffusing transparent lampshade 6. The phosphor mixture can be coated outside or inside or filled in the light diffusing transparent lampshade 6, or alternatively, the phosphor mixture together with transparent silicone and epoxy resin may be directly molded into the light diffusing transparent lampshade 6. The white light generated by exciting the inner-wall phosphor mixture using the blue light chips emits diffusive light at an angle of larger than 270 degrees. The phosphor mixture is separated from LED assemblies 2 with a certain gap.

The light diffusing transparent lampshade 6 has diameter larger than that of the substrate 1 and a shape of a spherical olive. The light diffusing transparent lampshade 6 is made of materials such as epoxy resin or transparent silicone or plastic glass.

In the LED lamp according to present patent application, the use of the light concentrating transparent lampshade effectively makes the irradiation light of the LED assemblies have concentration of light beam, strong penetration and sufficient illuminating intensity and realize the effect of concentrating light from different angles; the use of the light diffusing transparent lampshade effectively makes the irradiation light of the LED assemblies emit at an angle of larger than 270 degrees and evenly, thus the problem of glaring being avoided.

A detailed description of the present patent application described above is disclosed with reference to the preferred embodiment of the present patent application. It will be apparent to ordinary person skilled in the art that various improvements and modifications can be made to the present patent application without departing from the technical principle of the present patent application. Those improvements and modifications should also be regarded as protection scope of the present patent application.

1. A LED lamp, characterized in that, comprising a substrate on which LED assemblies are mounted, the surface of the LED assemblies being covered with transparent heat conductor and having a blocking wall arranged around; the LED assemblies are further coupled with a transparent lampshade that has a reflective ring provided thereon, the LED assemblies are disposed in a sealed cavity constituted by the substrate and the transparent lampshade, and phosphor mixture provided on the transparent lampshade is separated from the LED assemblies.

2. The LED lamp according to claim 1, wherein the transparent lampshade is a light concentrating transparent lampshade, which has a diameter less than that of the substrate and a shape of semi-oval convex lens, the light-concentration transparent lampshade being made of epoxy resin, transparent silicone or plastic glass.

3. The LED lamp according to claim 1, wherein the transparent lampshade is a light diffusing transparent lampshade, which has a diameter less than that of the substrate and a shape of a spherical olive, the light-diffusion transparent lampshade being made of epoxy resin, transparent silicone or plastic glass.

4. The LED lamp according to claim 1, wherein the transparent heat conductor is in a shape of concave lens or a plane lens or a convex lens.

5. The LED lamp according to claim 1, wherein each of the blocking wall and the light reflecting ring is made of heat-conductive plastic, rubber, or metal plated UV paint.

6. The LED lamp according to claim 1, wherein chips of the LED assemblies are blue light chips.

7. The LED lamp according to claim 1, wherein the substrate is made of ceramics or aluminum.

8. The LED lamp according to claim 1, wherein the phosphor mixture is coated outside, inside or filled in the transparent lampshade, or, the phosphor mixture together with transparent silicone or epoxy resin are directly molded into the transparent lampshade.

9. The LED lamp according to claim 1, wherein the transparent heat conductor is made of silicon rubber or epoxy resin.
